(19) United States
(12) Patent Application Publication
(10) Pub. No.: US 2020/0188789 A1
(43) Pub. Date: Jun. 18, 2020

(54) SYSTEMS AND METHODS FOR PROVIDING AN ON-LINE FANTASY SNEAKER LEAGUE USING HISTORICAL TRANSACTION INFORMATION

(71) Applicant: Colorway, Inc., Avon, CO (US)

(72) Inventors: Craig Michael Yarde, Mintum, CO (US); Michal Górski, Szczecin (PL)

(21) Appl. No.: 16/711,915

(22) Filed: Dec. 12, 2019

Related U.S. Application Data
(60) Provisional application No. 62/778,848, filed on Dec. 12, 2018.

(51) Int. Cl. A63F 13/65; G06Q 30/02

(52) U.S. Cl. CPC A63F 13/65; G06Q 20/123; G06Q 30/0206

(57) ABSTRACT

Systems and methods for providing an on-line fantasy sneaker league using historical transaction information are disclosed. A system may include game server system that provides an on-line sneaker fantasy league to user over a user device. The game server system retrieves historical transaction information transactions for each of the sneaker style available in the game from one or more third party shoe provider systems. The historical transaction information is then used to determine a game price for each sneaker style to begin game play and to fluctuate the game price of each sneaker style over the span of game play.

### CROSS-REFERENCE TO RELATED APPLICATIONS

This application claims the benefit of U.S. Provisional Patent Application Ser. No. 62/778,848, filed on Dec. 12, 2018, the entire content of which is expressly incorporated herein by reference.

### STATEMENT RE: FEDERALLY SPONSORED RESEARCH/DEVELOPMENT

Not Applicable

### BACKGROUND

The present disclosure relates generally to an on-line fantasy league game for buying and selling sneakers based on historical data for after-market sales of sneakers.

In recent years, many consumers have begun to collect, buy, sell, and/or trade sneakers as a hobby. To accommodate this hobby, an industry for after-market sneaker sales has arisen. For example, websites have been created where users may sell sneakers to other parties either directly or through a third-party service. On these websites, the price of a particular style of sneaker is often based upon the number of sneakers of the particular style that are in circulation (supply) and the popularity of the sneaker style (demand). The change in the price of a particular sneaker style may be tracked based on the sales price sales transaction records of the sneaker style. As this after-market sneaker sales industry has matured, the websites providing after-market sneaker sales are constantly trying to attract more users to gain a greater market share.

### SUMMARY

The above and other problems are solved and an advance in the art is made by systems and methods for providing an on-line fantasy sneaker league using historical transaction information in accordance with various embodiments of this disclosure. To attract users, an after-market sneaker sales website may provide entertainment, such as a game. One particular type of game that may be provided is a “fantasy league” for the buying and selling of sneakers. In this type of fantasy league, a player may start with a certain amount of money. The player then buys and sells sneakers in attempt to maximize the profit made from the sales over a set amount of time.

However, for such a game to hold the attention of players, the fictional game prices of the different sneaker styles need to reflect real world prices and fluctuate the game prices similar to how the sneaker prices fluctuate in the real-world market during gameplay. Additionally, if a game was designed to use buy and sell prices from the participants of the game, this may not reflect real world prices because the participants may artificially inflate prices or depress prices such as if a group of participants were to coordinate buys and sells of the sneaker style. It is also a problem to base a fictional game price of a sneaker style in the game, on the prices of real world historical transactions for the sneaker style because the change in price of a sneaker in the real world does not change much or at all during a short game period (e.g., 15 minutes) as contemplated in the present disclosure. Slow changes in price would make the game boring. Rather, any significant change in price in the real world that might be used in the game tends to take a longer period of time such as a day or week.

In accordance with the disclosure, a sneaker fantasy league game is provided by a system includes game server system. The game server system provides the on-line sneaker fantasy league to a player over a user device. The game server system retrieves historical information about transactions for each sneaker style available in the game from one or more third party shoe providers. The historical information is used to determine a game price for each sneaker style to begin game play and to fluctuate the price of each sneaker style over the span of game play. The game price is set based on the transaction prices to allow the game price to reflect the real world price. The prices in the historical transactions are then used to fluctuate the game price in a manner that reflects the fluctuation in the real-world price in the historical transactions to make the fluctuation of the game price reflect the trends and volatility exhibited by the transaction prices.

Users playing the game then monitor the game price of each sneaker style during game play and buy and/or sell sneaker styles based on the game price in an effort to make the greatest amount of profit over the period of the game.

### BRIEF DESCRIPTION OF THE DRAWINGS

FIG. 1 is a diagrammatic representation of systems and devices connected via a network that perform processes for providing an on-line fantasy sneaker league game in accordance with the disclosure.

FIG. 2 is a block diagram of a computer processing system in a game server system in accordance with the disclosure.

FIG. 3 is a representation of historical transaction information for a particular sneaker style in accordance with the disclosure.

FIG. 4A is a flow diagram of a process performed by a game server system to periodically obtain historical transaction information of one or more sneaker styles from one or more shoe transaction server systems independent of game play to maintain the most recent transaction information for each sneaker style in accordance with the disclosure.

FIG. 4B is a flow diagram of a process performed by a game server system to obtain historical transaction information for one or more sneaker styles when the transaction information is needed to calculate a game price of each of the sneaker styles and/or to fluctuate the game price during game play in accordance with the disclosure.

FIG. 5 is a representation of transaction information for various sneaker styles stored in memory by the game server system in accordance with the disclosure.

FIG. 6 is a flow diagram of a process performed by the game server system to provide an on-line fantasy league game in accordance with the disclosure.

FIG. 7 is a screen shot of a “market” display of sneaker styles available during gameplay in accordance with the disclosure.

FIG. 8 is a screen shot of a “my sneakers” display showing a sneaker style inventory of a player in accordance with the disclosure.

FIG. 9 is a screen shot of an individual sneaker style display in accordance with the disclosure.

FIG. 10 is a screen shot of a “sell” interface for a sneaker style in accordance with the disclosure.

FIG. 11 is a screen shot of a “buy” interface for a sneaker style in accordance with an embodiment of the disclosure.

FIG. 12 is a flow diagram of a process performed by a game server system to determine a game price of a sneaker style based on historical transaction information in accordance with the disclosure.

FIG. 13 is a flow diagram of a process performed by a game server system to fluctuate the game prices of a sneaker style during gameplay in accordance with the disclosure.

### DETAILED DESCRIPTION

Systems and methods in accordance with various embodiments of this disclosure provide an on-line sneaker fantasy league game using historical transaction information. In accordance with some embodiments, each player uses a personal device, such as a smart phone or a tablet, to play the game. The personal device communicates with a game server system that provides the game.

In accordance with the disclosure, two (2) modes of the game are contemplated, a “live” mode and a “practice” mode. Prior to game play in either mode, transaction records for each sneaker style are obtained from one or more shoe transaction server systems. The transaction records are records of sales of the sneaker styles maintained by the one or more shoe transaction systems. The transaction records obtained for each sneaker style are then sorted and stored in memory for later use in providing gameplay.

The transaction records are used in the following manner in the “live” mode. Game time in “live mode” is fifteen (15) minutes. A set of the five (5) most recent transaction records is obtained for each sneaker style at the beginning of game play. The set of the five (5) most recent transaction records of each sneaker style are used to determine an initial game price for each sneaker style. The game price is fluctuated or modified every two minutes based on the set of the five (5) most recent transaction records until the game time expires.

The transaction records are used in the following manner in the “practice” mode. Game time for “practice” mode is fifteen (15) minutes. A set of five (5) transaction records is obtained for each sneaker style at the beginning of game play. The five (5) selected transaction records may be any five transactions records available in memory. The five (5) transaction records of each sneaker style are used to determine an initial game price for each sneaker style. The game price is fluctuated or modified every two minutes based on the selected five (5) transaction records until the game time expires.

To play the game, each player joins a league that includes at least one player. Each league is provided in one of the two game modes. The player competes against the other players and/or themselves in the league to accumulate as much profit as possible by buying and selling sneaker styles based on game prices of the sneaker styles set by the game provider. At the end of the game time period, the players may be ranked in the league based on at least one of the following parameters: profit made, total money in an account, total worth of inventory of sneakers, or any combination of the preceding parameters. A more detailed description of the devices and systems that provide a sneaker fantasy league game and the processes performed by the described devices and system is given below with reference to the drawings.

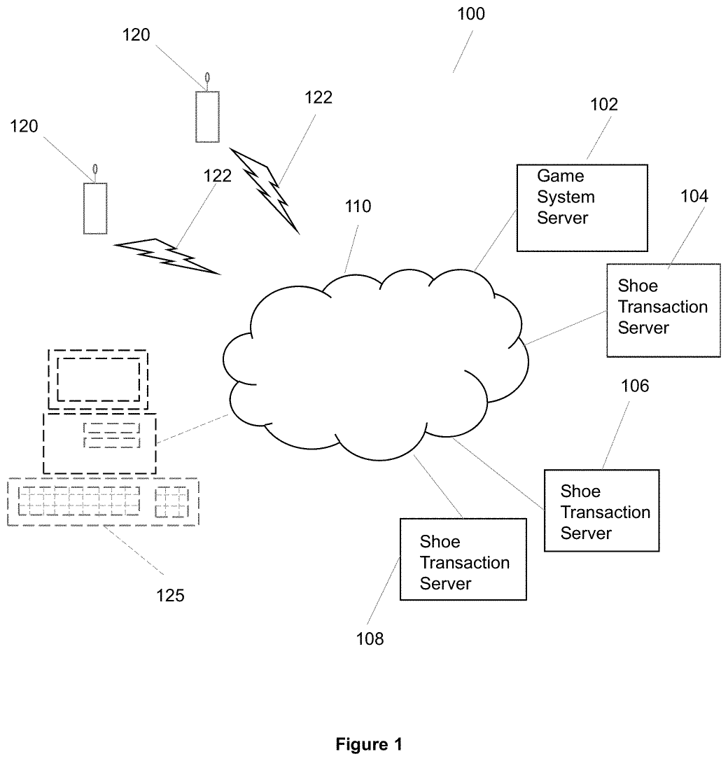

FIG. 1 illustrates a system 100 for providing an on-line sneaker fantasy league game using historical transaction information in accordance with an embodiment of the disclosure. The system 100 includes a game server system 102; shoe transaction servers 104, 106, and 108; and user devices 120 and 125 that are communicatively connected by a network 110.

The game server system 102 is a system that provides the fantasy league game to players via a personal device over the network. To do so, the gaming server system 102 performs processes that obtain transaction information for each type of sneaker provided in the game from one or more third party shoe transaction providers, determines the game price for each sneaker style available in the game and fluctuates the game price of each sneaker style during game play. Game server system 102 may include one or more servers, routers, computer systems, and/or memory systems that are communicatively connected via an internal network to perform the game management processes and provide the game to players.

The shoe transaction server systems 104, 106, and 108 are each a computer system that includes a memory and a processing unit to perform processes for storing and providing transaction information about the sales of sneakers between two or more parties. To provide an on-line fantasy sneaker game in accordance with some embodiments of the invention one or more of the shoe transaction server system 104, 106, and 108 provides transaction information for each sneaker style stored by the system to the game server system 102. Each shoe transaction server system 104, 106 and 108 may be implemented by a system that includes one or more servers, routers, computer systems, and/or memory systems that are communicatively connected via a network to store and provide transaction information for one or more types of sneakers.

The network 110 may advantageously be the Internet. Alternatively, the network 110 may be a Wide Area Network (WAN), a Local Area Network (LAN), or any combination of Internet, WAN, and LAN that can be used communicatively to connect the various devices shown in FIG. 1.

A player uses a personal device, such as a portable personal communication device 120 or computer system 125 to connect to game server system 102 to play the on-line sneaker fantasy league game in accordance with the shown embodiment. In some games, only one player will be connected to the game server system and play a game in a league by themselves to practice and/or attempt to achieve a “personal best” in the game. In some other games, more than one player may each be connected to the game server system using their own personal communication devices 120 and play in a league that provides “head to head” competition. Each portable personal communication device 120 may be a smart phone, tablet, Personal Digital Assistant (PDA), a laptop computer, or any other device that is connectable to the network 110 via wireless connection 122. The computer system 125 connects to the network 110 via either a conventional “wired” or a wireless connection. The computer 125 may be, for example, a desktop computer, a laptop, a smart television, and/or any other device that connects to the network 110 using a “wired” or wireless connection.

Although a particular system of devices is described above with respect to FIG. 1, other system architectures that, add, remove, and/or combine various devices and/or modules may be used to perform various processes in accordance with various other aspects of the disclosure.

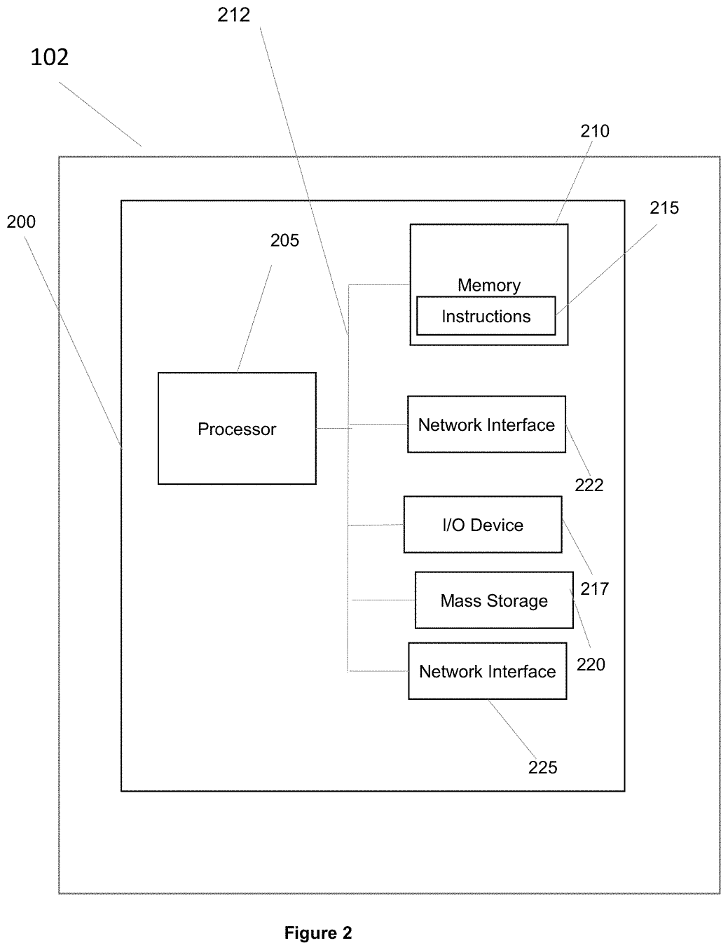

FIG. 2 is a high-level block diagram showing an example of the architecture of a processing system 200 of a computer system in game server system 102 according to some embodiments of the disclosure. The processing system 200 can represent a computer system that performs one or more processes that provide an on-line sneaker fantasy league game in accordance with an embodiment of the disclosed system. Certain standard and well-known components of a processing system which are not germane to the subject matter of this disclosure are not shown in FIG. 2.

Processing system 200 includes one or more processors 205 in operative communication with memory 210 and coupled to a bus system 212. The bus system 212, as shown in FIG. 2, is a schematic representation of any one or more separate physical buses and/or point-to-point connections, connected by appropriate bridges, adapters and/or controllers. The bus system 212, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The one or more processors 205 are the central processing units (CPUs) of the processing system 200 and, thus, control its overall operation. In certain embodiments, the one or more processors 205 accomplish this by executing software stored in memory 210. The processor(s) 205 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 210 represents any form of random-access memory (RAM), read-only memory (ROM), flash memory, or the like, or a combination of such devices. Memory 210 includes the main memory of the processing system 200. Instructions 215 implementing the process steps of processes described below may reside in memory 210 and are executed by the processor(s) 205 from memory 210.

Also, advantageously connected operatively to the processor(s) 205 through the bus system 212 are one or more internal or external mass storage devices 220, and a network interface 222. The mass storage device(s) 220 may be, or may include, any conventional medium for storing large volumes of data in a non-volatile manner, such as one or more solid state, magnetic, or optical based disks. The network interface 222 provides the processing system 200 with the ability to communicate with remote devices (e.g., storage servers) over a network, and may be, for example, an Ethernet adapter, a Fiber Channel adapter, or the like.

The processing system 200 also advantageously includes one or more input/output (I/O) devices 217 operatively coupled to the bus system 212. The I/O devices 217 may include, for example, a display device, a keyboard, a mouse, etc.

Although an example of an architecture of a processing system is described above with respect FIG. 2, other architectures of processing systems that add, combine, and/or remove are possible in accordance with various other embodiments of this disclosure.

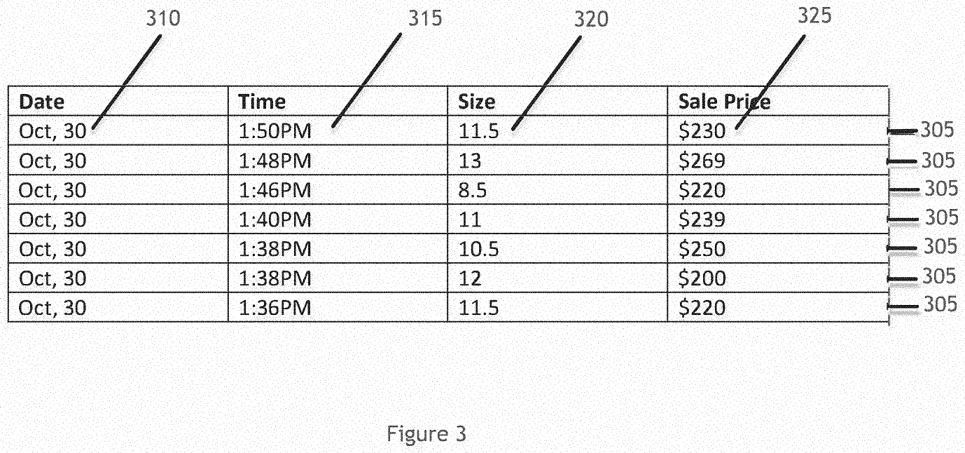

To provide, an on-line sneaker fantasy league in accordance with some embodiments of this disclosure, the gaming system server obtains historical transaction information for sales of each sneaker style provided in the game. An example of transaction information for a sneaker style in accordance with an embodiment of the disclosure is shown in FIG. 3. The transaction information includes transaction records 305. Each transaction record 305 includes the information for one transaction of the sneaker style including, but not limited to, date information 310, time information 315, and a sale price 325. Date information 310 indicates the date the transaction was completed. Time information 315 indicates the time of day of the transaction. Sale price 325 indicates the price at which the sneaker style sold. In addition, each transaction record may include other types of information that describe the sneaker, and/or the transaction performed to sell the sneaker. For example, each record 305 is shown to include shoe size information 320 that indicates the shoe size of the pair of sneakers involved in the transaction. The shoe size information 320 may be used to determine the game price by selecting transaction records that include particular shoes sizes (e.g. popular shoe sizes such as sizes 9 and 10) for use in determining and/or fluctuating the game price of a sneaker style. It is further contemplated that any other type of information about a transaction that may be needed to determine a game price may be included in accordance with various other embodiments.

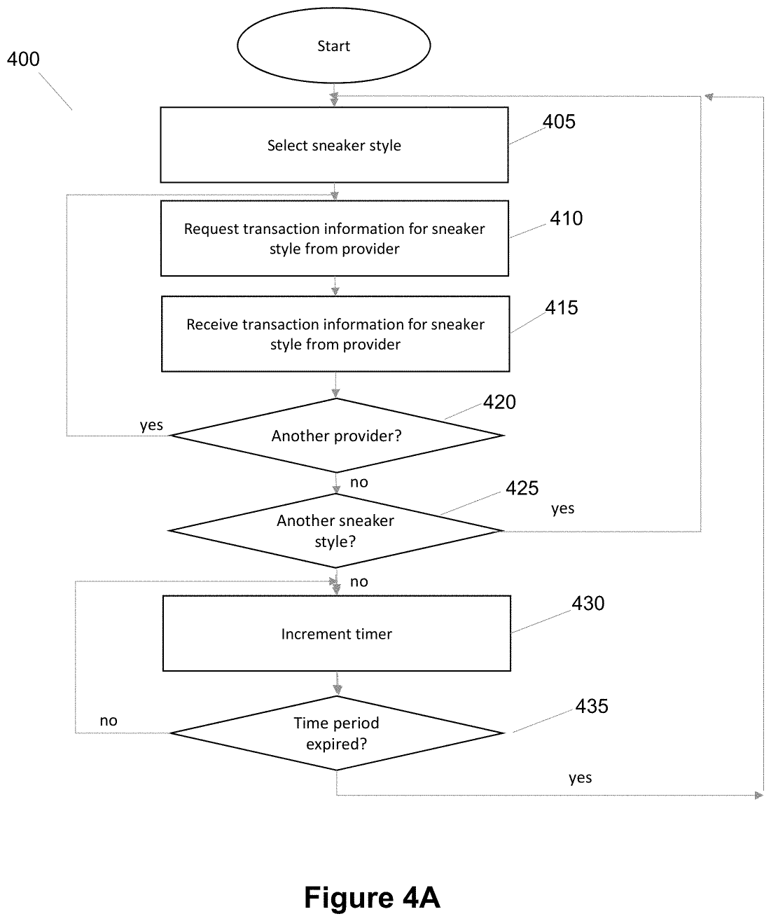

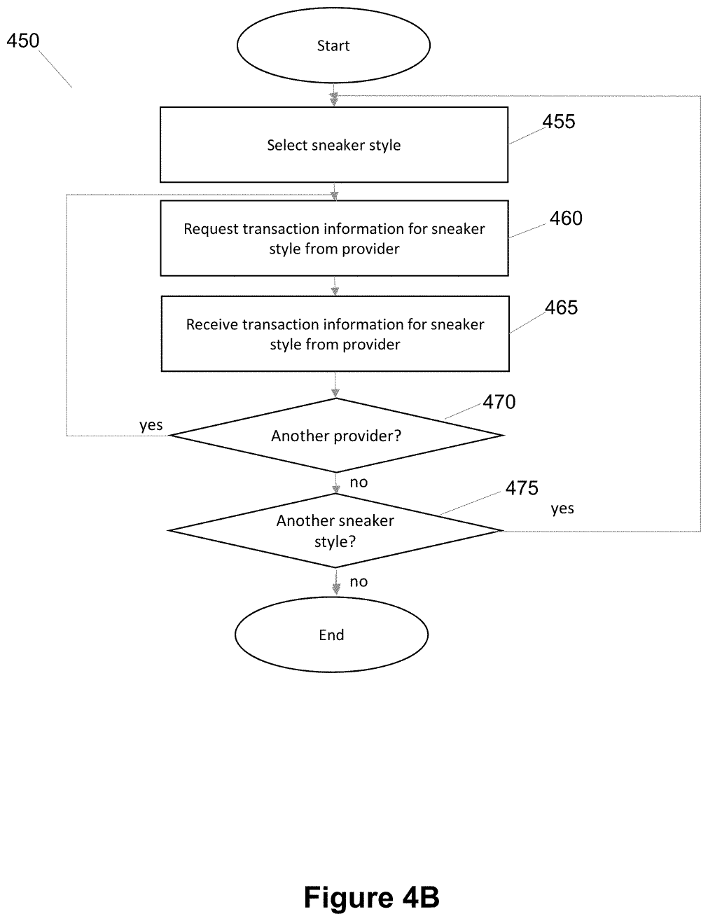

To provide an on-line sneaker fantasy league game using historical transaction information in accordance with the disclosure, a game server system needs to obtain the historical transaction information. In accordance with the disclosure, there are two possible processes for obtaining the shoe transaction information: a continuously updating process and an on-demand process. The continuously updating process periodically obtains the show transaction information independent of providing a game and is performed independent of the state of the game. A process performed by a game server system to periodically obtain transaction information in accordance with the disclosure is shown in FIG. 4A.

In some other embodiments, transaction information for each sneaker type provided in the game is obtained from the one or more shoe transaction server systems when new transaction information is needed by the game server system to set and/or fluctuate the game prices of the sneaker styles during game play. An on-demand process performed by the game server system to obtain transaction information for each sneaker style provided in the game is shown in FIG. 4B.

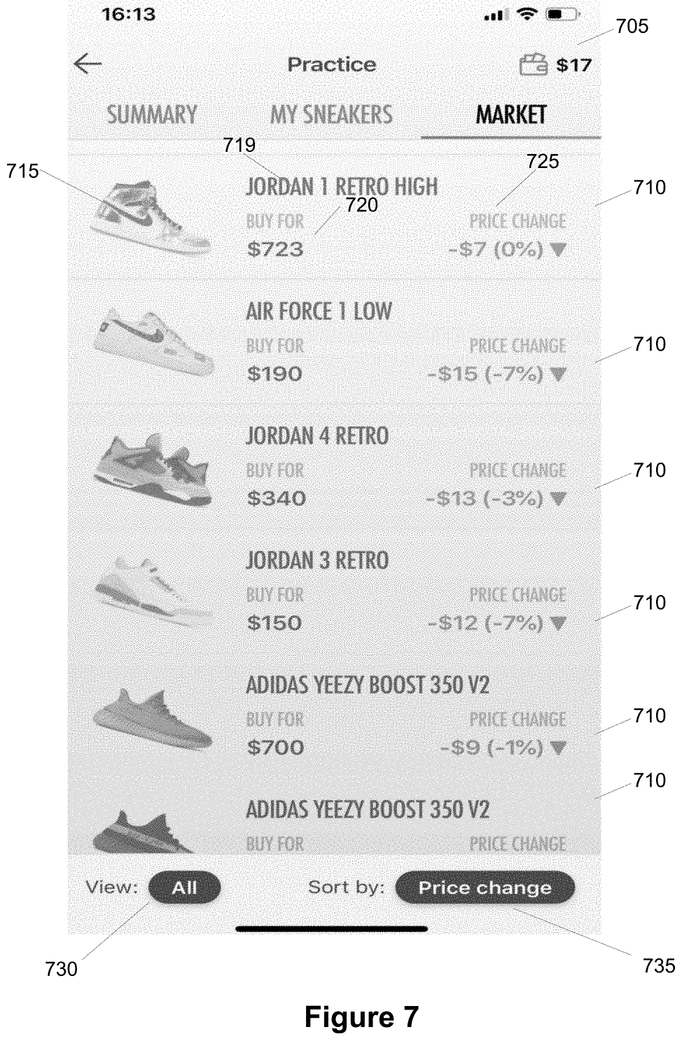

A process performed by the game server system to periodically obtain transaction information from the one or more shoe transaction servers independent of providing gameplay in accordance with an embodiment of the disclosure is shown in FIG. 4A. In process 400, a sneaker style is selected (405). The sneaker style is one of the sneaker styles provided during gameplay. For example, the sneaker style is one of the sneaker styles shown in a “market” during game play as shown in FIG. 7 and discussed below. A request to obtain transaction information for the selected sneaker style is generated and transmitted to one of the of the shoe transaction server systems (410).

In response to the request, transaction for the selected sneaker style is received from the shoe transaction server system that received the request (415). The process determines whether there is another shoe transaction server system from which to obtain transaction information for the selected sneaker style (420). In accordance with this disclosure, the game server system may maintain a list, file, or some other data structure that stores a list of shoe transaction server systems that provide transaction information and uses the list to select the shoe transaction server system from which to obtain information until the transaction information for a sneaker style is obtained from all of the shoe transaction server systems. If yes, process 400 repeats the requesting (410) and receiving of transaction information of the selected sneaker style (415) for another shoe transaction server.

If no, the process 400 determines whether there is another sneaker style for which transaction information is needed (425). In accordance with the disclosure, transaction information for each sneaker style shown in the “market” for a game is needed. To obtain the transaction information for each provided sneaker style, a list of sneaker styles is maintained and used to determine the sneaker style to select until all of the sneaker styles have been selected. If yes, process 400 is repeated from the selecting of a sneaker style (405) for another sneaker style. If no, process 400 increments a timer (430) and determines whether a specified time period has expired (435). In accordance with the disclosure, the specified period may be twenty (20) minutes. However, the time period may be any other period of time in accordance with various other embodiments of the disclosure. If no, the process 400 repeats incrementing the timer (430) until a determination that the time has expired. If yes, the process 400 repeats from the selecting of a sneaker style (405) to obtain the transaction information for a new time period.

The above describes a process for periodically obtaining transaction information for each of the sneaker styles provided in a game in accordance with one embodiment of the disclosure. However, other processes that add, combine, remove, and/or reorder the steps of the process are possible.

An on-demand process performed by the game server system to obtain transaction information from the one or more shoe transaction server systems during gameplay and/or as required to provide gameplay in accordance with the disclosure is shown in FIG. 4B. For example, in some embodiments, the game server system may need to obtain a new set of five (5) transaction records to update the game prices and/or fluctuate the game price at the end of a transaction period that may last twenty (20) minutes. For purposes of this discussion, a transaction period is a period of time in which a particular set of transaction records for a sneaker style is used to determine a game price for the style and/or fluctuate the game price during gameplay. Furthermore, the length of the transaction period may vary in accordance with various other embodiments. For example, the transaction period may be equal to, greater than, or less than a game period. If the transaction period is equal to the game period then the start of the transaction period may be offset (e.g., between 30 seconds to 5 minutes) from the game period so that recent transaction records can be obtained to calculate the initial game price right before the start of the game period.

To obtain new transaction information, process 450 selects a sneaker style (455). The selected sneaker style is one of sneaker styles provided during gameplay as is shown in the “market” shown below and discussed with reference to FIG. 7. A request to obtain transaction information for the selected sneaker style is generated and transmitted to one of the of the shoe transaction server systems (460).

In response to the request, transaction information for the selected sneaker style is received from the shoe transaction server system that received the request (465). The process 450 determines whether there are other shoe transaction server systems from which to obtain transaction data (470). In accordance with this disclosure, the game server system may maintain a list, file, or some other data structure that stores a list of shoe transaction server systems that provide transaction information and uses the list to select the shoe transaction server system from which to obtain information until the transaction information for a sneaker style is obtained from all of the shoe transaction server systems. If yes, process 450 repeats the requesting (455) and receiving of transaction information of the selected sneaker style (460) for another shoe transaction server.

If no, the process 450 determines whether there is another sneaker style for which transaction information is needed (475). In accordance with the disclosure, transaction information for each sneaker style shown in the “market” for a game is needed. To obtain the transaction information for each provided sneaker style, a list of sneaker styles is maintained and used to determine the sneaker style to select until all of the sneaker styles have been selected. If yes, process 450 is repeated from the selecting of a sneaker style (455) for another sneaker style. If no, the process 450 ends.

The above describes an on-demand process for obtaining transaction information for each of the sneaker styles provided in a game when new transaction information is needed in accordance with one embodiment of the disclosure. However, other on-demand processes that add, combine, remove, and/or reorder the steps of the described process are possible.

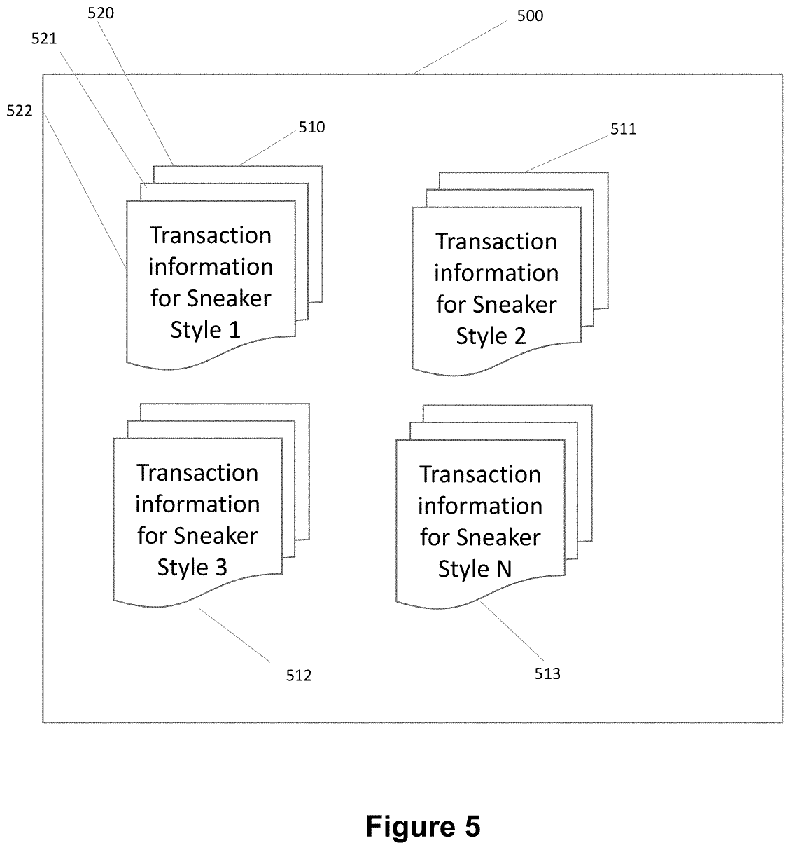

Once transaction information for each of the sneaker styles is obtained by the game server, the game server system stores the transaction information of each sneaker style for use in determining and/or fluctuating a game price of the sneaker style during the provision of a game. To do so, the game server system may process the transaction records to order the transaction records received from the one or more shoe transaction server systems in some manner. In accordance with the disclosure, the transaction records are arranged based on time and/or date. However, other parameters in the transaction records may be used for ordering the records in accordance with various other embodiments. A memory that stores the transaction records for each type of sneaker provided in the game is shown in FIG. 5.

The memory 500 stores the transaction information for each of the sneaker styles. The memory 500 may store the transaction information in a database maintain to store or manage the records, files that each store transaction information for one of the sneaker styles provided or in any other type of data structure that may be used to order the transaction records in a usable manner. Memory 500 stores transaction information 510 for sneaker style 1, transaction information 511 for sneaker style 2, transaction information 512 for sneaker style 3, and transaction information for any number of additional sneaker styles including transaction information 513 for sneaker style N. Each set of transaction information 510-513 includes multiple transaction records 520-522 for the sneaker style. In accordance with the disclosure, all of the transaction records that are periodically obtained are stored in some embodiments. In accordance with some other embodiments, only the five most recent transaction records are stored for each sneaker style provided in the game. However, the number of transaction records stored for each sneaker style may vary in accordance with some other embodiments. Furthermore, although the transaction information for each sneaker style is shown to include the same number of transaction records, the number of transaction records stored for each sneaker style provided in the game may vary due to any number of factors including, but not limited to, the amount of transaction records available for each sneaker style.

In accordance with the disclosure, the game server system provides an on-line fantasy league game in either a “live” mode or a “practice” mode. To add excitement to the game, the game server system determines a game price of each sneaker style and fluctuates the game price of each sneaker style based on the obtained transaction information for the sneaker styles in both modes. Preferably, the game price of each sneaker style in the game is set to reflect the actual price of the sneaker styles in the obtained transactions and the fluctuations of the game price reflect the general trend and volatility of changes in the transaction price in the obtained transaction records. In the “live” mode, game time is fifteen (15) minutes. The “live” mode of the game is provided in the following manner. A most recent set of five (5) transaction records is obtained for each sneaker style at the beginning of game play via the on-demand process described in relation to FIG. 4B. The five (5) transaction records of each sneaker style are used to determine an initial game price for each sneaker style. The game price is fluctuated or modified every two minutes based on the five (5) transaction records until the game time expires.

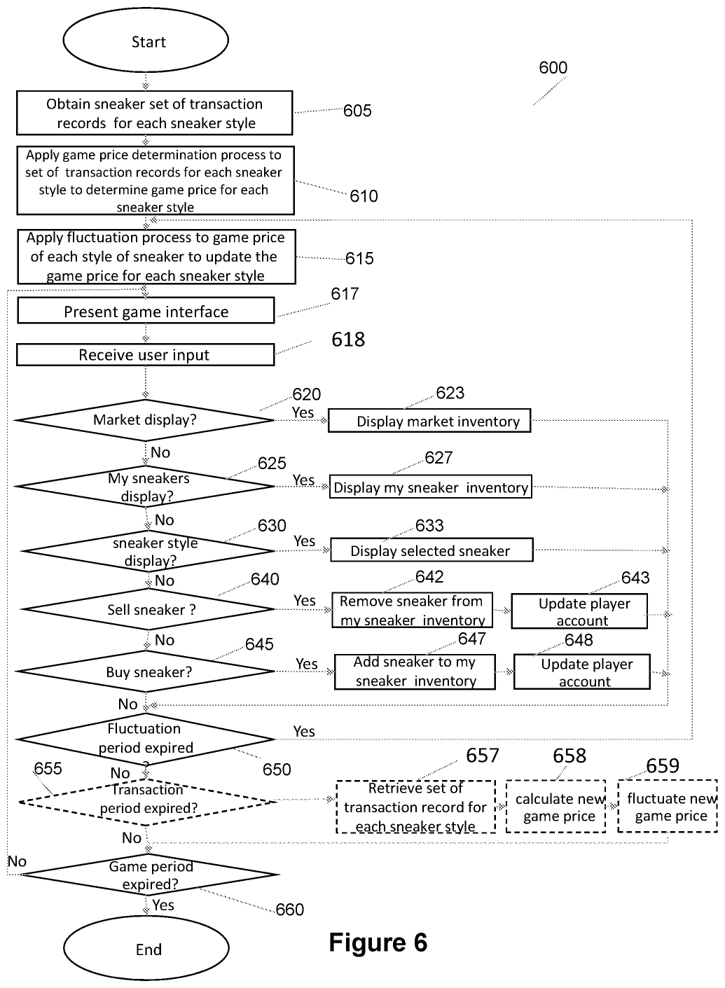

In the “practice” mode, game time is fifteen (15) minutes. Gameplay for the “practice” mode is provided in the following manner. A set of five (5) transaction records is obtained for each sneaker style at the beginning of game play. The set of five (5) transaction records may be based on a specified time period, or in any other manner. The specified time period may be such as the recent past such as 1 hour, 1 day, 1 month, or 1 year ago. It is not the most recent data. The five (5) transaction records of each sneaker style are used to determine an initial game price for each sneaker style. The game price is fluctuated or modified every two minutes based on the five (5) transaction records until the game time expires. FIG. 6 illustrates a flow diagram of a process 600 performed by the game server system to provide a sneaker fantasy league game in either “live” mode or practice mode in accordance with the disclosure. To provide the “live” and “practice” modes a fluctuation period is set to 2 minutes and the game time period is set to fifteen (15) minutes. In the process 600, a set of transaction records for each sneaker style provided in the game is obtained (605). In the “live” mode, the most recent five (5) transaction records for each sneaker style provided in the game and in the “practice” mode, 5 consecutive transaction records are obtained which are not the most recent. In accordance with the disclosure, these transaction records may be retrieved from memory. However, in some embodiments, these transaction records may be obtained from one or more shoe transaction server systems. In accordance with some other embodiments, any number of transaction records for each sneaker style may be obtained. For example, in various embodiments, a set of 1 to 20 transaction records are obtained and more preferably a set of between 1 and 10 transaction records are obtained. In accordance with many other embodiments, all of the transaction records stored in a memory for each sneaker style may be obtained. In accordance with still other embodiments, all of the transaction records for a certain time period may be obtained.

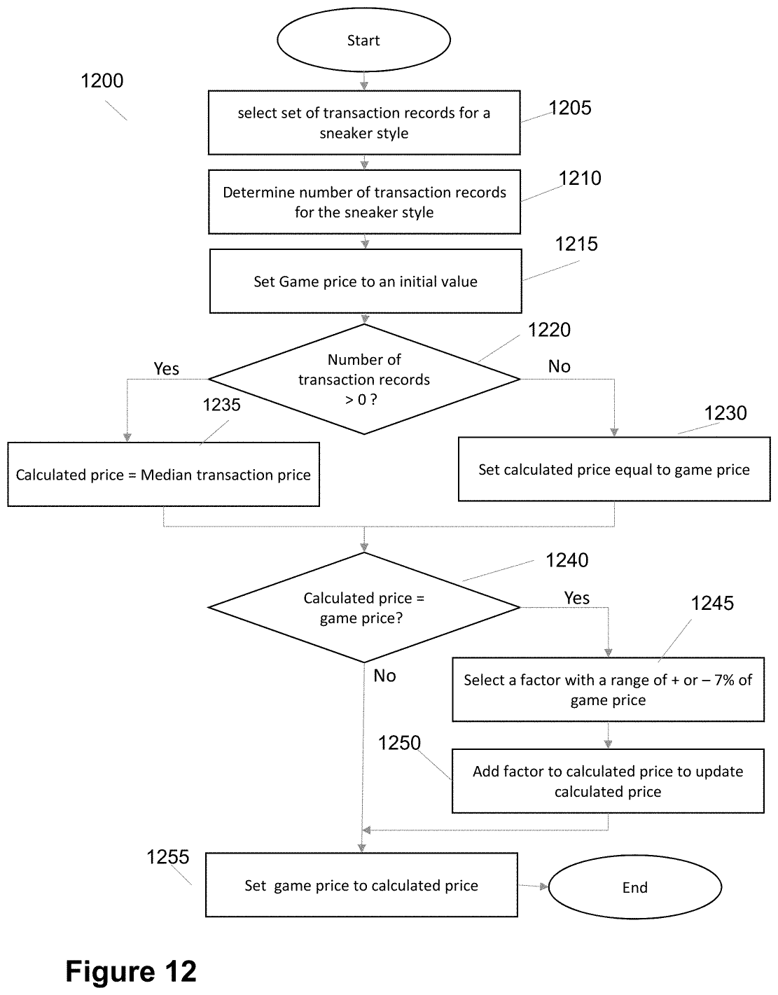

A game price determination process is then performed on the set of transaction records for each sneaker style provided in the game to determine a starting game price for each provided sneaker style (610). A price determination process in accordance with the disclosure sets the game price to reflect the price in the most recent transactions to allow the game price of each sneaker style to reflect the prices of the sneaker styles in the real world. A price determination process in accordance with the disclosure is described below in more detail with reference to FIG. 12. However, different price determination processes may be used in accordance with various other embodiments.

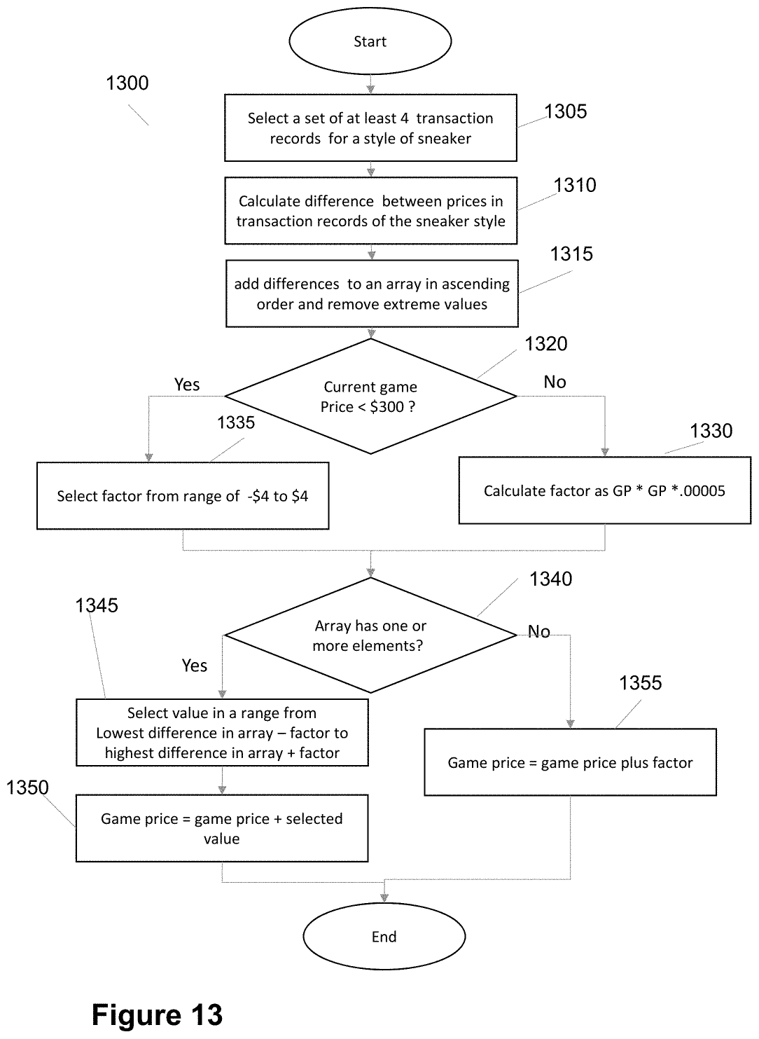

The game price is then fluctuated by applying a fluctuation process to the game price of each provided sneaker style using the set of transaction records of each provided sneaker style (615). A fluctuation process may add or subtract a random value to the game price; and/or multiply the game price of each sneaker style by a constant to cause the game price of each sneaker style to vary in a manner that reflects trend of price movement in the set of transaction records of each sneaker style and with a volatility in game price that reflects the volatility in the prices in the set of transaction records. A fluctuation process in accordance with the disclosure is described below with reference to FIG. 13. However, different fluctuation processes may be used in accordance with various other embodiments.

A user connects to the game server system using a personal device, registers to play in a league, and is ready to commence game. Several players may connect to the game server system concurrently and each is able to play games in one or more leagues. When gameplay for a league commences, a game interface is provided (617) by the game server system to a personal device of each player in the league for display and to allow the player to interact with the game.

The process 600 monitors for an input by the player. When an input is received from the user (618) the process determines a proper action to take. The process 600 determines whether a request for displaying a “market” is received (620). In accordance with the disclosure, a “market” that includes all of the sneaker styles currently available in the game. If yes, a display including information for each of the sneaker styles available is provided to the user device (623). A screen shot of a “market” display in accordance with the disclosure is discussed below with reference to FIG. 7.

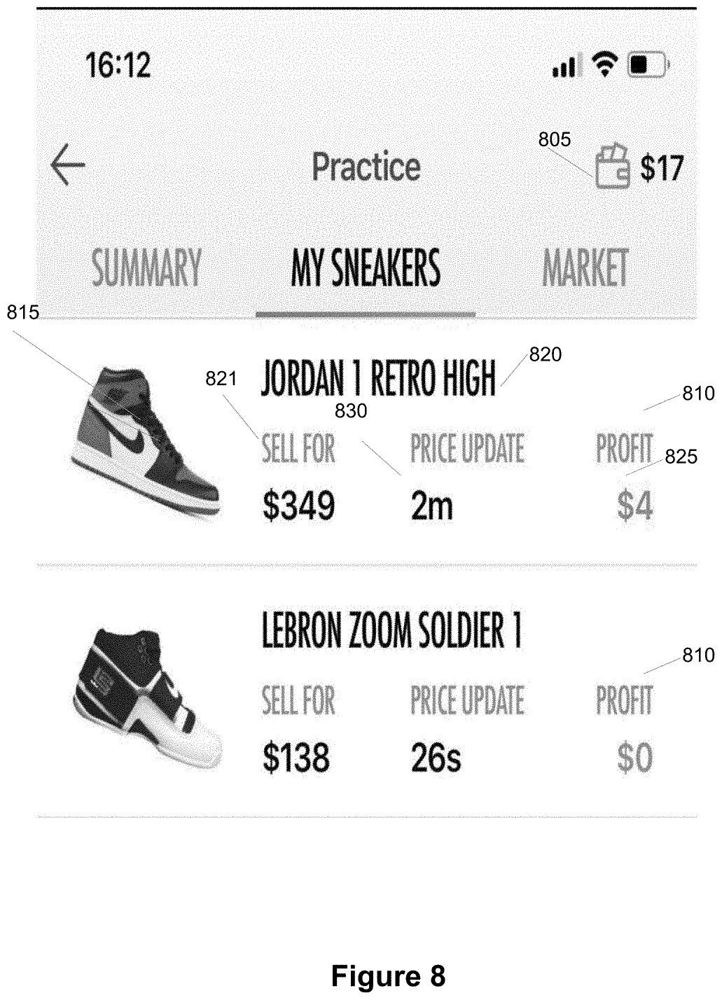

If no, process determines whether a request for a “my sneaker” display is received (625). The “my sneaker” is a display of the inventory of sneaker styles that the player currently owns. A screen shot of a “my sneakers” display is discussed below with reference to FIG. 8. If yes, the game server system provides “my sneaker” display with an inventory of all of the sneaker styles currently owned by the player to the user device of the player (627).

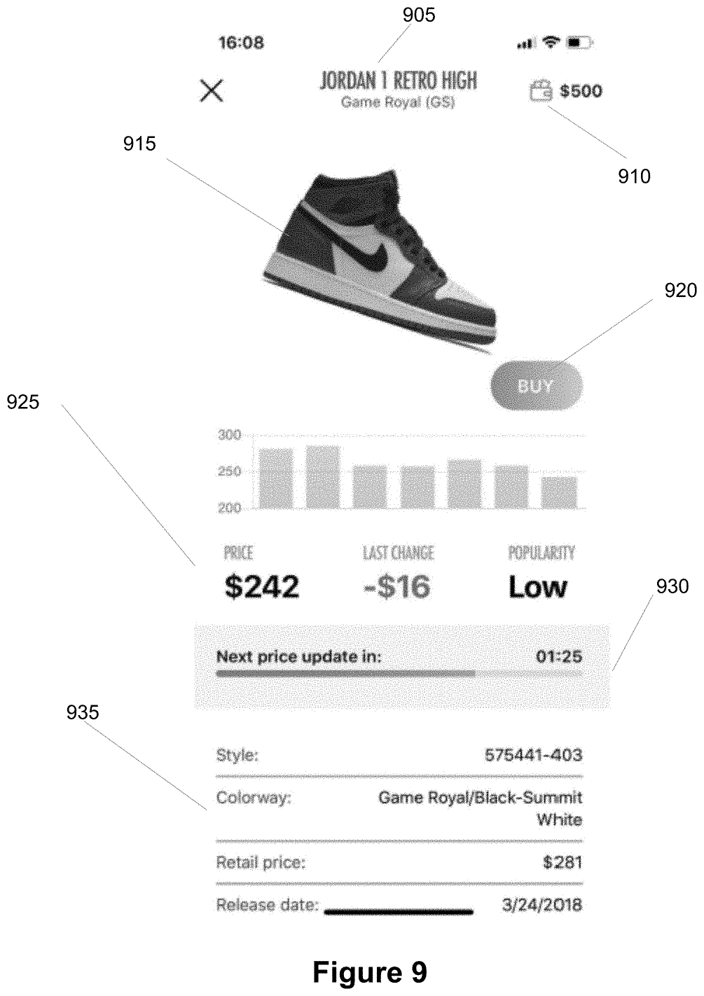

If no, process 600 determines whether a display of an individual sneaker style is received (630). A display for an individual sneaker style shows current game information about the selected sneaker style. A screen shot of an individual sneaker style display in accordance with the disclosure is discussed below with reference to FIG. 9. If yes, the game server system provides a display of the requested individual sneaker style to the user device for display to the user (6033).

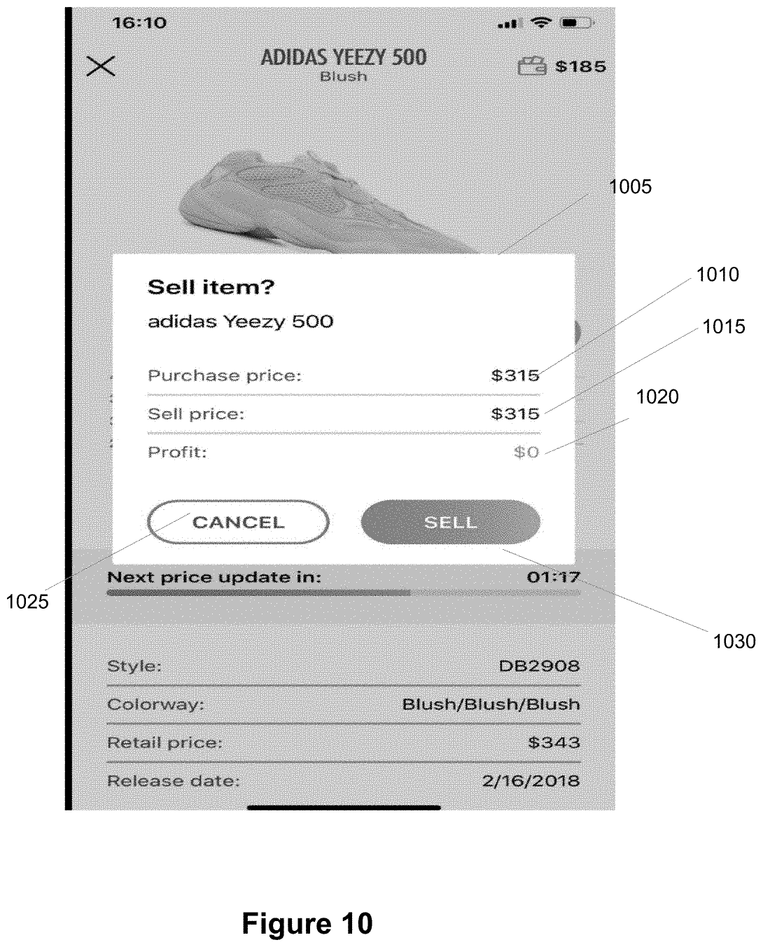

If no, the process 600 determines whether a sell sneaker style request is received (640). A screen shot of a sell interface for use to input a sell request is discussed below with reference to FIG. 10. In accordance with the disclosure, the request identifies a type of sneaker to sell. In some further embodiments, the request may also include a sale price for the identified sneaker style. If yes, the requested sneaker style is removed from the sneaker inventory of the player (6042) and the player account is updated to include the sales price of the sneaker (6043).

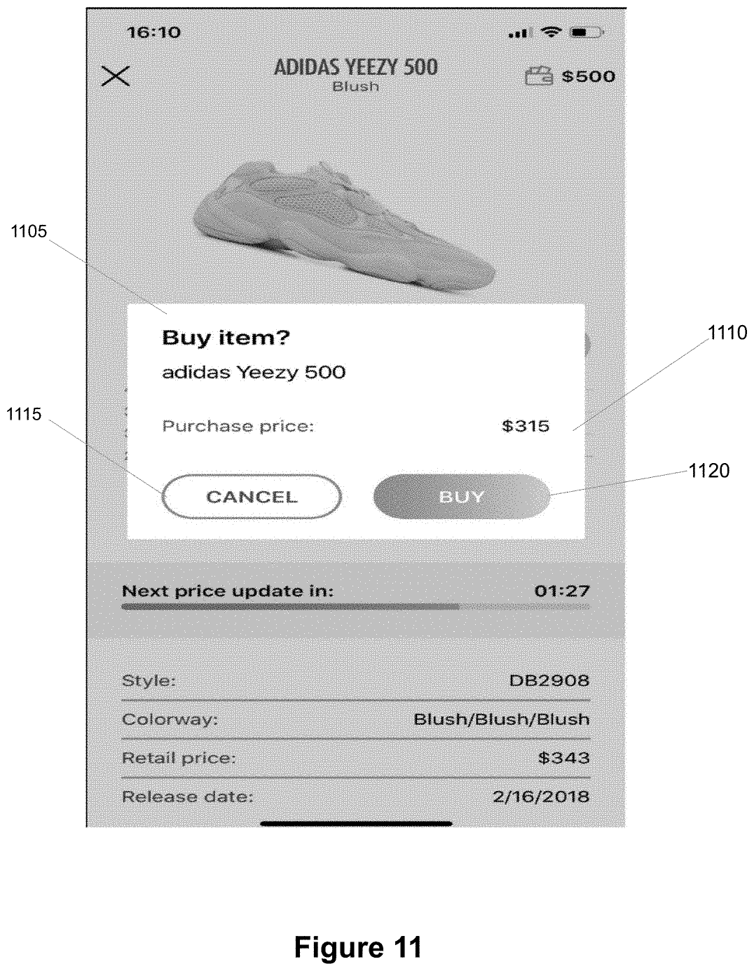

If no, the process 600 determines whether a buy sneaker style request is received (640). A screen shot of a buy interface for use to input a buy request is discussed below with reference to FIG. 11. In accordance with the disclosure, the buy request identifies a type of sneaker to buy. In some further embodiments, the request may also include a sale price for the identified sneaker style. If yes, the requested sneaker style is added to the sneaker inventory of the player (647) and the player account is updated to subtract the sales price of the sneaker for the player account (648).

After an input is received and processed and/or if no, the process 600 determines whether a fluctuation period has ended (6050). A fluctuation period is a time between changes in the game price during gameplay. In accordance with the disclosure, the fluctuation period is two (2) minutes. However, any other period of time may be used in accordance with various other embodiments. For example, the fluctuation time may be selected from a range of one (1) to fifteen (15) minutes (the game period) and more particular from a range of one (1) to five (5) minutes. Furthermore, in some embodiments, the fluctuation times for the different sneaker styles may be varied and/or be staggered to cause the game price of the different sneaker styles to fluctuate at different times during gameplay. If yes, process 600 repeats from the application of the fluctuation process (615).

If no, the process 600 optionally determines whether a transaction period has ended (655). A transaction period is a time period in which an obtained set of transaction records is used to determine and fluctuate the game price of a sneaker style. In accordance with the disclosure, a transaction period is determined independent of gameplay and expires every twenty (20) minutes. In accordance with some other embodiments, various other amounts of time may be used to determine a transaction period. For example, the transaction period may be selected from a range of one (1) minute to one (1) hour and more preferably between ten (10) minutes and forty-five (45) minutes. In accordance with still other embodiments, the transaction period may be shorter than the game period. For example, a transaction period expires every five minutes in a fifteen-minute game. In still further other embodiments, the transaction time periods of each individual sneaker style may be varied or staggered to cause the transaction time periods of different sneaker styles to expire at different times.

It is noted that in the “live” mode and the “practice” mode, the transaction period may be equal to, greater than or less than the game period. As such, in some instances, the set of transaction records that are used to determine and fluctuate the game price does not change for the entire game period such as when the game period is shorter than the transaction period and the start of the transaction period is starts before the start of the game period to set the initial game price.

If yes, a new set of transaction records for each sneaker style provided is obtained (657). Obtaining the transaction records may be performed by retrieving the information from memory of the game server or per process shown in FIG. 4A or 4B. The new set of transaction records includes any five (5) transaction records for each sneaker style provided in the game. As discussed above, the next five transaction records may be read from transaction records stored in memory or may be obtained from the one or more shoe transaction systems when needed. In accordance with some other embodiments, any number of transaction records for each sneaker style may be obtained. For example, the number of transaction records that may be obtained is selected from a range of one (1) to twenty (20) and more preferably from a range between five (5) and ten (10). In accordance with many other embodiments, all of the transactions records retrieved since the expiration of the last transaction period for each sneaker style may be obtained. In accordance with still other embodiments, all of the transaction records for a certain time period may be obtained.

The new set of transaction records of each sneaker style is used to calculate a new game price for each of the sneaker styles by applying the game price determination process (658). As discussed above, a game price determination process in accordance with the described embodiment is described below with reference to FIG. 12.

The new game price for each sneaker style is fluctuated by applying the fluctuation process (659). As discussed above, a fluctuation process in accordance with the described embodiment is described below with reference to FIG. 13.

After the new price is fluctuated or if no, the process determines whether a game play period has expired (660). In accordance with the disclosure, the game play period is fifteen (15) minutes. However, other time periods may be used for the game play period in accordance with various other embodiments. For example, the game play period may be between fifteen minutes and a day. More particularly, the game play period may be between thirty (30) minutes to an hour. If no, process 600 is repeated from the presenting of the interface (617). If yes, the process 600 may end. In some embodiments, the process 600 may include further steps for evaluating and/or ranking the players in a league after the game play period has expired.

Although an exemplary process performed by the game server system to provide an on-line sneaker fantasy league in accordance with the described embodiment of this disclosure is discussed above with respect to FIG. 6, other processes performed by the that add, combine, rearrange, or remove steps are possible and are considered within the scope of this disclosure.

FIG. 7 shows a screen shot of a “market” display in accordance with the disclosure. The “market” display includes a display field 710 for each sneaker type provided in the game, a current account balance information field 705, a view filter field 730, and a sorting selection field 735. The account balance information field 705 provides a current amount of cash available to the user. In accordance with some other embodiments, other pertinent information to the user may also be displayed in this portion of the display.

The view filter field 730 allows a user to select a particular set including one or more of the provided sneaker styles to display. In the described embodiment, the possible arrangements are provided in a “drop down window” and may include, but are not limited to, all, most popular, most expensive, least expensive, and show brands.

The sorting selection field 735 allows a user to select a manner in which the individual sneakers are presented in the “market”. In accordance with the described embodiment, the sort by field includes “drop down” window that show the sorting options that may include, but are not limited to, price change, game price, maker, and style.

Each display field 710 for a sneaker style includes an image of the sneaker style 715, a name of the sneaker style 719, a current game price 720, and a price change from the previous price 725. Other embodiments may provide additional information about the sneaker style that may be of use to a player in deciding whether to obtain the sneaker style in the game.

Although an example of a screen shot of a “market” display for an on-line sneaker fantasy league game in accordance with the disclosure is described above with reference to FIG. 7, other displays that add, remove, combine, or rearrange components of the “market” display are possible in accordance with various other embodiments of this disclosure.

FIG. 8 shows a screen shot of a “my sneakers” display for a player in accordance with the disclosure. The shown “my sneakers” display includes a player account information area 805, and a display field 810 for each sneaker style currently owned by the player. The player account information area 805 includes information pertinent to the account of the player. As shown, this information may include the current profit of the player and/or the balance the player's account. In accordance with some other embodiments, other information of the player's account may alternatively or additionally be displayed in the player account information area 805. The display fields 810 for each sneaker type include an image of the sneaker style 815, a name of the sneaker style 820, a current game price 821, a potential profit to the user if the style is sold 825, and a time to price update field 830 that indicates the amount of time until the price of the sneaker style will change. Other embodiments may provide additional information about the sneaker style that may be of use to a player in deciding whether to obtain the sneaker style in the game.

Although an example of a screen shot of a “my sneakers” display for an on-line sneaker fantasy league game in accordance with the disclosure is described above with reference to FIG. 8, other displays that add, remove, combine, or rearrange components of the “my sneakers” display are possible in accordance with various other embodiments of this disclosure.

FIG. 9 illustrates a screen shot of an individual sneaker display in accordance with the disclosure. The individual sneaker display includes a name 905 of the displayed sneaker style, user account information 910, an image of a sneaker of the sneaker style 915, an action button 920, a game price history portion 925, a time to next price update 930, and sneaker style information 9355. The action button 920 may be to “buy”, to “sell”, and/or some other game-based action that a user may perform that is based upon whether or not the player owns the sneaker style. The game price history portion 925 may give information about the game price including, but not limited to, the current price, the change in value from a previous game price to the current game price and a popularity indication for the sneaker style. The time to next update 930, is a clock, a countdown slider, or similar type display that shows the time until the next change in price for the particular style of sneaker. The sneaker style information 935 includes information about the particular sneaker style including, but not limited to, a style serial number, the colors available, the retail price, and the release date of the sneaker style.

Although an example of a screen shot of an individual sneaker style display for an on-line sneaker fantasy league game in accordance with the disclosure is described above with reference to FIG. 9, other displays that add, remove, combine, or rearrange components of the individual sneaker style display are possible in accordance with various other embodiments of this disclosure.

FIG. 10 is a screen shot of a “sell” window that is disposed over an individual sneaker display when a sell action button is selected in accordance with the disclosure. The “sell” window 1005 includes a purchase price 1010, a sell price 1015, the profit to be gained/lost 1020, a sell confirmation button 1030, and a cancel button 1025. The purchase price 1010 is an indication of the price at which the user purchased the sneaker style. The sell price 1015 is the price at which the user is selling the sneaker style. The profit to be gained/lost 1020 is the difference of the sell price from the purchase price. The “sell” confirmation button 1030 is a user selectable button on the interface that may be selected to finalize the sale. The cancel button 1025 is a user selectable button that is selected to void the transaction of selling the sneaker style.

Although an example of a screen shot of “sell” window display for an on-line sneaker fantasy league game in accordance with the disclosure is described above with reference to FIG. 10, other displays that add, remove, combine, or rearrange components of the “sell” window display are possible in accordance with various other embodiments.

FIG. 11 is a screen shot of a “buy” window that is disposed over an individual sneaker display when a buy action button is selected in accordance with the disclosure. The “buy” window 1105 includes a purchase price 1110, a buy confirmation button 1120, and a cancel button 1115. The purchase price 1110 is an indication of the price at which the user is to purchase the sneaker style. The “buy” confirmation button 1120 is a user selectable button on the interface that may be selected to finalize the sale of the sneaker style to the user. The cancel button 1115 is a user selectable button that is selected to void the transaction of buying the sneaker style.

Although an example of a screen shot of “buy” window display for an on-line sneaker fantasy league game in accordance with the disclosure is described above with reference to FIG. 11, other displays that add, remove, combine, or rearrange components of the “buy” window display are possible in accordance with various other embodiments.

FIG. 12 illustrates a flow diagram of game price determination process performed by the game server system to determine the game price for a sneaker style in accordance with the disclosure. A game price determination process determines a game price for a sneaker style that reflects the real word price of the sneaker style using the transactions records for each sneaker style. In particular, the process 1200 is performed using each set of transaction records to determine a game price of each sneaker style as discussed above with reference to 610 and 653 of FIG. 6.

In process 1200, a set of transaction records for the sneaker style is selected (1205). In accordance with the disclosure, five (5) transaction records are selected. In accordance with some embodiments, the transaction records may be randomly selected from the transaction records for the sneaker style stored in memory. In other accordance with some other embodiments, the transaction records are selected based on age (e.g. the five newest records). By way of example and not limitation, the set of transaction records may indicate sales prices of $307, $400, $325 and $300 at 12:00 noon, 12:20 pm, 12:40 pm and 1 pm on a day. In the “live” mode, the first set of transaction records are the most recent or newest transaction records. In the “practice” mode, the set of transaction records are the most recent or newest transaction records available from memory. It is also contemplated that the set of transaction records may be older such as more than 1 day old but it is preferably not older than 2 weeks or 30 days.

The number of records obtained is determined (1210). For example, in some cases there may not be five available transaction records for the sneaker style and the number of transaction records obtained needs to be determined. The game price is then set to an initial value (1215). In accordance with the disclosure, the initial price is the price in one of the selected transaction records. In accordance with some other embodiments, the initial price may be a manufacturer's suggested retail price and/or a suggested price from a buyer's guide.

The process 1200 determines whether the number of transaction records is greater than zero (0) (1220). If yes, a calculated price is determined (1235). In the above example, the number of transaction records is greater than zero because the number of transaction records equals 4. In accordance with the disclosure, the calculated price is set to the median transaction price of the five selected transaction records. However, other numbers of transaction records may be used in accordance with various other embodiments. Furthermore, another property of the prices in the set of transaction records may be used including, but not limited to, the average or mean of the sale prices in the set of transaction records in accordance with other embodiments. For example, the average or mean of the exemplar transaction records is (300+325+400+307)/4=333. The calculated price may be set to $333. In the example provided herein, the calculated price will be set to $300 for the purposes of illustration.

If no, the sneaker style is new or no transaction records for sales of the style available. In this case, the calculated price is set to the current game price (1230) or the manufacturer's suggested retail price.

The calculated price is compared to the current game price to determine whether the calculated price is equal to the game price (1340). If no, the game price is set to the calculated price (1255) and process 1200 ends. If yes, a randomizing factor is randomly selected from a range of plus or minus seven percent (7%) of the game price (1245). In accordance with some other embodiments, the range may be based on different percentages. For example, the percentage may be selected from a range of one (1) to twenty (20) percent and more particularly from a range between three (3) and ten (10) percent. In accordance with still other embodiments, the factor may be selected by a specific equation applied to the calculated price or the factor selected in some non-random, predictable manner.

The randomizing factor is then added to the calculated price to update the calculated price (1250). For example, if the randomizing factor is 3%, then calculated price may be $309. The game price is then set to the updated calculated price (1255) and process 1200 ends.

An exemplary game price determination process in accordance with the disclosure is described above with respect to FIG. 12. Other game price determination processes that add, combine, rearrange, and/or remove one or more steps described above are possible in accordance with other embodiments.

To cause the game price of a sneaker style to behave similar to the price in real world transactions during the compressed time of game play, a fluctuation process may be applied that uses the transaction records from real world transactions to change the game price. The fluctuation process causes the change in game price to emulate the trend of the change in the prices in the set of transaction records. Furthermore, the fluctuation process causes the change in the game price to emulate the volatility in the prices in the set of transaction records. To do so, the fluctuation process adds a factor to the game price based on a range between lowest and highest differences in transaction prices. For example, the lowest difference for a set of transaction may be −$25 and the greatest difference may be $4. If a value is selected from this range, the value is likely to be negative. The value may be less frequently a positive number because the range is mostly in the negative area. It would be 6.25 (25/4=6.25) times more likely to be a negative number than a position number. As such, when the factor is added to the game price, the new value will likely follow the downward trend for the game price while sometimes increasing the game price to emulate the volatility in the game prices based on the set of transaction records or real-world transaction prices. In the described embodiment, a fluctuation process is performed at the end of a fluctuation period that is two minutes for a fifteen-minute game. However, the length of the fluctuation period may be changed based on the length of the game time and/or the amount of desired volatility in the game prices. FIG. 13 illustrates a flow diagram of a process performed by the game server system to fluctuate the game price of a sneaker style in accordance with the disclosure. The process 1300 is performed for each sneaker style provided at the end of each fluctuation period and when a new game price is determined as discussed above with reference to 615 and 654 of FIG. 6.

In the process 1300, four (4) transaction records are selected (1305). By way of example and not limitation, the set of transaction records may indicate sales prices of $307, $400, $325 and $300 at 12:00 noon, 12:20 pm, 12:40 pm and 1 pm on a day. In accordance with the disclosure, the price from one of the five obtained transaction records may be used to set the game price and the remaining four (4) transaction records may be used to in the process 1300. Furthermore, a different number of transaction records may be selected in accordance with various different embodiments depending on the amount of transaction records obtained in by the game process as discussed above with reference to FIG. 6.

The difference between the transaction prices may be calculated (1310). In the above example, the differences in transaction prices may be +$4 ($307-$303), +$93 ($400-$307), −$75 ($325-$400) and −$25 ($300-$325). The price of $303 was not shown in the four transaction records above but may be obtained and used to calculate the transaction price difference. Alternatively, the difference between the current game price and the transaction price in each transaction record may calculated. The calculated differences are then added to an array (e.g., −$75, −$25, +$4, +$93), and the extremes of the differences in the array (e.g. least and greatest differences) are removed (1315). (e.g., −$75 and +$93 are removed, only −$25 and +$4 are left in the array).

The process 1300 then determines whether the current game price is less than $300 (1320). Other embodiments may use another price as a threshold. However, $300 is selected because it best represents the threshold where the fluctuation of transactions varies in relation to the price of the sneaker style for current day after market shoe sales. In some embodiments, this price threshold may be selected at any price in a range from one-dollar ($1) to five hundred dollars ($500) and more particularly from a range from two hundred and fifty dollars ($250) to three hundred ($300) dollars. In accordance with some of these embodiments, the threshold price may be determined based upon a lowest price of a shoe style having at least an average number of shoe transactions for a set of shoe styles having at least 3 transactions per month. If yes, a factor is selected from a range between −$4 and $4 (1335). In accordance with various other embodiments, other ranges may be used. In particular, the range may be selected from prices anywhere in a range from −$20 to $20 and more particularly a range from −$10 to $10. Preferably, this factor is selected to be between + or −0.5% to 3% of the threshold price. If no, the factor is calculated based on the following equation: Factor=(Current game price)*0.0005. The coefficient 0.0005 may be between 0.0001 and 0.0010 and is preferably between 0.0003 and 0.0008. The higher numbers are used to make higher price shoes more volatile.

After the factor is selected and/or calculated, the process 1300 determines whether the array has more than one element (1340). If yes, a value is randomly selected (1345) from a range from the lowest difference (e.g., −$25) in the array minus the factor (1335, 1330) to the highest difference (e.g., +$4) in the array plus the factor (1335, 1330). The new game price is then set to be the selected value added to the current game price (1350) and process 1300 ends. If no, the game price is set (1355) to the current game price added to the calculated or selected factor (1335, 1330) and process 1300 ends.

As used herein the transaction record represents one shoe transaction. However, it is also contemplated that the transaction record may be an average of transactions over a period of time. By way of example and not limitation, the four transaction records used in relation to FIG. 13 and in the other figures may be an average price of a sneaker style over the course of four consecutive days, weeks or months or any other equal periods of time. In this way, any short-term trend changes in price will not dictate the trend emulated by the game. Rather, the longer-term trend of the price of the sneaker style would be reflected in the game. Those that buy and sell used sneakers would be able to more advantageously play the game because they would know the real trend in prices for the sneaker styles. In this way, those with real world knowledge of sneaker style prices and trends would feel as if they are playing with real prices and with trends that they recently recognized for the shoes that they follow.

Additionally, although the context of the game is described in relation to the buying and selling of shoes, it is also contemplated that the game may be used to buy and sell other commodities such as but not including old game consoles and antiques.

The above description is given by way of example, and not limitation. Given the above disclosure, one skilled in the art could devise variations that are within the scope and spirit of the invention disclosed herein. Further, the various features of the embodiments disclosed herein may be used alone, or in varying combinations with each other and are not intended to be limited to the specific combination described herein. Thus, the scope of the claims is not to be limited by the illustrated embodiments.

What is claimed is:

1. A system for providing an on-line sneaker fantasy league game, comprising:
at least one processor; and
memory readable by the least one processor and storing instructions that, when read by the at least one processor, direct the at least one processor to:
obtain a set of transaction records for sales of a sneaker style from a sneaker transaction system, each of transaction record in the set of transaction records including a sales price for a transaction,
determine a game price for the sneaker style based on at least one transaction record from the set of transaction records, and
fluctuate the game price of the sneaker style during game play at end of a fluctuation period based on at least one transaction record from the set of transaction records.

2. A method for determining a game price for a sneaker style in an on-line sneaker fantasy league provided by a game server system comprising:
obtaining a set of transaction records for sales of a sneaker style from a sneaker transaction system using a game server system, each of transaction record in the set of transaction records including a sales price for a transaction,
determining a game price for the sneaker style based on at least one transaction record from the set of transaction records using the game server system, and
fluctuating the game price of the sneaker style during game play at end of a fluctuation period based on at least one transaction record from the set of transaction records using the game server system.

3. A non-transient machine readable media accessible by at least one processor in a game server system that when read by the at least one processor directs the processor to perform the method comprising:
obtaining a set of transaction records for sales of a sneaker style from a sneaker transaction system, each of transaction record in the set of transaction records including a sales price for a transaction,
determining a game price for the sneaker style based on at least one transaction record from the set of transaction records, and
fluctuating the game price of the sneaker style during game play at end of a fluctuation period based on at least one transaction record from the set of transaction records.
